(19) United States
(12) Patent Application Publication
(10) Pub. No.: US 2013/0186536 A1
(43) Pub. Date: Jul. 25, 2013

(54) VALVE DEVICE FOR TUBELESS TIRE

(71) Applicant: Chin Chuan LEE, ChangHua (TW)

(72) Inventor: Chin Chuan LEE, ChangHua (TW)

(21) Appl. No.: 13/353,486

(22) Filed: Jan. 19, 2012

(51) Int. Cl. B60B 21/12

(52) U.S. Cl. 152/427

(57) ABSTRACT

A wheel rim device includes a rim member having a bridge extending between two side walls, and a valve device having a valve stem engaged with the bridge and having a sealing member attached to the valve stem for engaging with the bridge and for anchoring the valve stem to the bridge of the rim member and for making an air tight seal between the valve stem and the rim member, and the sealing member includes a casing engaged onto the valve stem and engaged between the valve stem and the bridge for further making a solid and stable air tight seal between the valve stem and the rim member. The casing is engaged onto a flanged head of the valve stem for engaging with the bridge.

### BACKGROUND OF THE INVENTION

1. Field of the Invention

The present invention relates to a valve device for a tubeless tire, and more particularly to a valve device for tubeless tires, particularly those used in show cars, bicycles, motor cycles, tricycles, unicycles, or the like, although the invention need not be limited thereto.

2. Description of the Prior Art

Typical valve devices for bicycles, motor cycles, unicycles, tricycles, show cars, or the like require custom installation of the valve stem into a wheel rim, and comprise a valve stem to be attached or mounted or secured or engaged into the drilled hole of the wheel rim, and a gasket or sealing member required to be mounted or engaged between the wheel rim and the valve stem for making an air tight seal between the valve stems or devices and the wheel rim.

For example, U.S. Pat. No. 4,760,860 to Madrona, U.S. Pat. No. 4,819,685 to Pagani, and U.S. Pat. No. 5,211,782 to Thelen disclose several of the typical valve devices for bicycles, and the wheel rim must therefore be customed drilled to provide a close tolerance hole for accepting the valve stem, and the hole must be countersunk to accept the top of the valve stem body. It is therefore necessary that the wheal rim be custom-machined to accept the valve body.

The valve bodies of the typical valve devices lack a suitable provision for sealing the valve body to avoid loss of air, and a separate gasket or sealing member is further required to be mounted or engaged between the wheel rim and the valve stem for making an air tight seal between the valve stems or devices and the wheel rim. However, a suitable air tight seal for the valve devices is important for the driver of the cycle vehicles, and the loss of the air or the flat tire during a race can result in loss of control over the car and extreme danger to the driver.

However, the attachment or mounting or securing of the typical valve devices to the wheel rim with the gaskets or sealing members is not good enough to make a suitable air tight seal between the valve devices and the wheel rim, thereby making it difficult to achieve a secure fixation of the valve body of the valve devices in the wheel rim.

The present invention has arisen to mitigate and/or obviate the afore-described disadvantages of the conventional valve devices for cycles.

### SUMMARY OF THE INVENTION

The primary objective of the present invention is to provide a valve device for tubeless tires, particularly those used in show cars, bicycles, motor cycles, tricycles, unicycles, or the like, including a solid and stable air tight seal.

In accordance with one aspect of the invention, there is provided a wheel rim assembly comprising a rim member including two side walls, and including a bridge extending between the side walls, and including an aperture formed in the bridge, and a valve device including a valve stem engaged with the aperture of the rim member, and including a sealing member attached to the valve stem for engaging with the bridge and for anchoring the valve stem to the bridge of the rim member and for making an air tight seal between the valve stem and the rim member, and the sealing member including a casing engaged onto the valve stem and engaged between the valve stem and the bridge for making the air tight seal between the valve stem and the rim member and for forming a solid and stable air tight seal between the valve stem the valve device and the rim member.

The valve stem includes a flanged head having an outer diameter greater than that of the valve stem for forming an abutment between the valve stem and the flanged head and for engaging with the bridge and for anchoring the valve stem to the bridge of the rim member. The casing is engaged onto the flanged head and the abutment of the valve stem for engaging with the bridge and for further making the air tight seal between the valve stem and the rim member.

The valve device includes a tube attached to the valve stem, and includes a compartment formed in the tube, and includes a valve seat formed in the tube, and includes a valve piece received in the compartment of the tube and having a valve head for selectively engaging with the valve seat of the tube and for selectively sealing or blocking the compartment of the tube and for controlling the air to selectively flow through the tube.

The valve piece includes a gasket engaged with the valve head for selectively engaging with the valve seat of the tube and for selectively sealing or blocking the compartment of the tube. The gasket is engaged onto the valve piece and engaged with the valve head.

The tube includes at least one guide slot or rib extended in the compartment thereof, and the valve piece includes at least one guide member for engaging with the guide slot or rib of the tube and for guiding the valve piece to slide along the tube and for preventing the valve piece from being rotated relative to the tube, and for guiding the valve head to move toward or away from the valve seat of the tube.

The valve device includes a lock nut threaded with a threaded shank of the valve piece and engaged with the tube for moving the valve head toward or away from the valve seat of the tube. The lock nut includes an opening formed therein and arranged for allowing the air to flow into the compartment of the tube even when the lock nut is engaged with the tube.

The valve stem includes a threaded segment threaded with the tube for attaching the tube to the valve stem, and the threaded segment includes an outer diameter smaller than that of the valve stem for forming an annular shoulder between the valve stem and the threaded segment.

The casing is engaged onto the annular shoulder of the valve stem for engaging with the tube. The tube includes an outer thread formed thereon for engaging with a fastener and for mounting the tube of the valve device to the rim member. The side walls of the rim member are converge and are joined together to form a base, and the base includes an orifice formed therein for receiving and engaging with the tube.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a cross sectional view of a valve device for a cycle in accordance with the present invention;

FIG. 2 is another cross sectional view similar to FIG. 1, illustrating the operation of the valve device;

FIG. 3 is a partial exploded view of the valve device for the cycle;

FIG. 4 is another partial exploded view of the valve device for the cycle similar to FIG. 3, in which a base sealing member has been removed;

FIG. 5 is a further cross sectional view of the valve device similar to FIGS. 1 and 2, in which the base sealing member and the wheel rim have been removed; and

FIGS. 6, 7 are still further cross sectional views similar to FIG. 5, illustrating the formation or the attachment of the base sealing member to the wheel rim of the valve device.

### DETAILED DESCRIPTION OF THE PREFERRED EMBODIMENT

Referring to the drawings, and initially to FIGS. 12, a wheel rim assembly 1 in accordance with the present invention comprises a rim member 10 including a profiled structure having a substantially A-shaped section, with two side walls 11 which converge and are joined together to form a base 12, and a bridge 13 extending between the two side walls 11 for forming or defining an inner chamber 14 by the bridge 13 and the base 12. The rim member 10 further includes an outer peripheral channel 15 formed or defined by the bridge 13 and the tire-holding fins 16 that are formed or extended from the radially outer portions of the side walls 11, for coupling to a tire (not shown), particularly a tubeless tire.

It should be noted that the base 12 is not only defined as the inner peripheral joining zone between the two side walls 11 (which in turn can be relatively narrow as in the illustrated example or narrower or wider), but more generally the portion of the side walls 11 below the bridge 13. The rim member 10 is provided with an inflation valve device 3 mounted in respective aligned orifice 17 and aperture 18, the orifice 17 is formed in the base 12, the aperture 18 is formed in the bridge 13. It should be noted that the tubeless tire (not illustrated) is mounted on the wheel rim member 10, the valve device 3 is mounted airtight on the orifice 17 and/or the aperture 18 of the wheel rim member 10. The above-described structure or configuration for the wheel rim member 10 is typical for cycles and will not be described in further details.

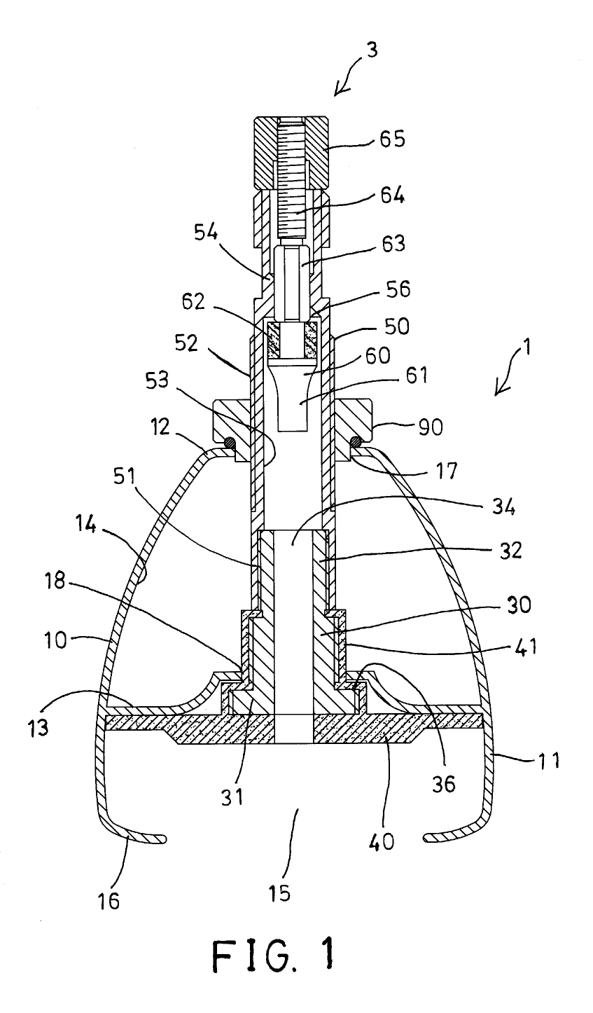

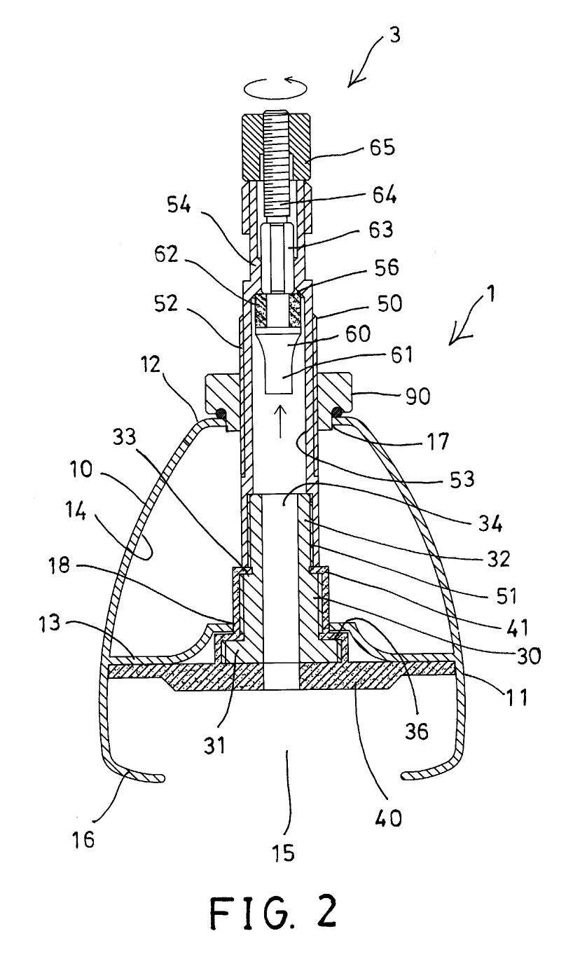

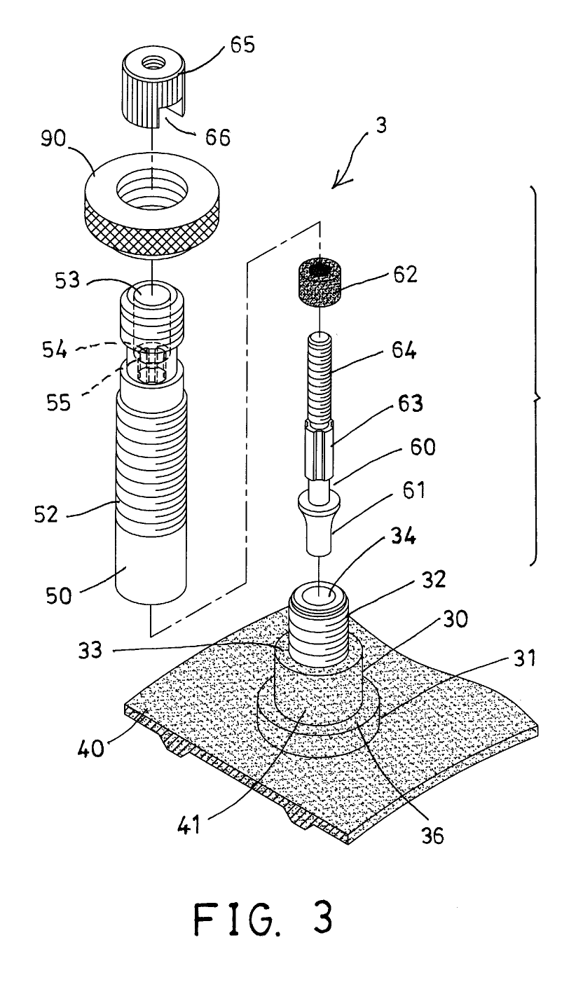

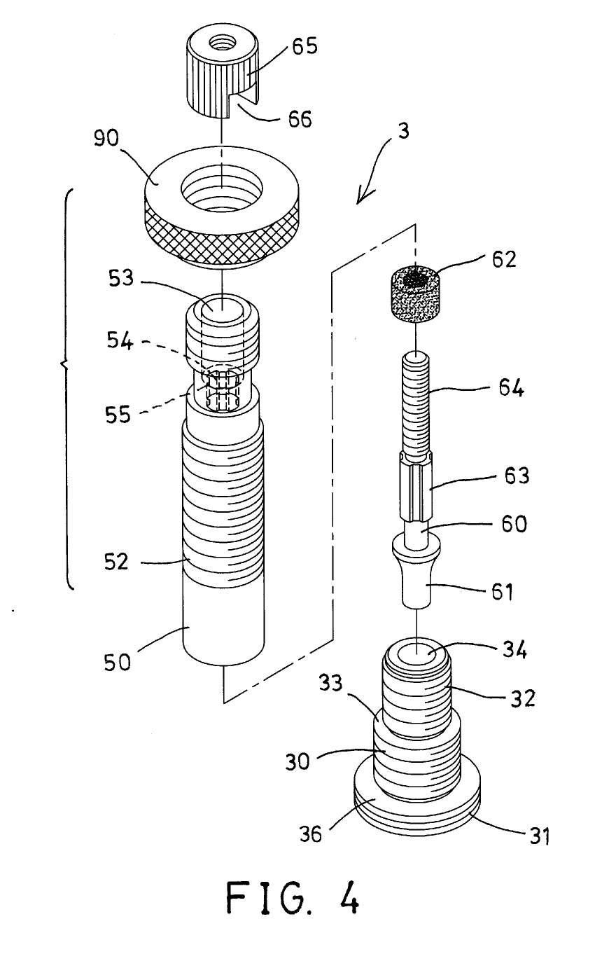

As also shown in FIGS. 1-2 and further in FIGS. 3-5, the valve device 3 includes a valve stem 30 for engaging into or through the aperture 18 that is formed in the bridge 13 of the wheel rim member 10, and includes an enlarged or flanged head 31 formed or extended from the valve stem 30 and having an outer diameter greater than that of the valve stem 30 for engaging with the bridge 13 and for anchoring or securing or retaining or positioning the valve stem 30 to the bridge 13 of the wheel rim member 10, and includes a narrowed or reduced threaded segment 32 located opposite to or distal to the enlarged or flanged head 31 and having an outer diameter smaller than that of the valve stem 30 for forming or defining an annular shoulder 33 between the valve stem 30 and the threaded segment 32.

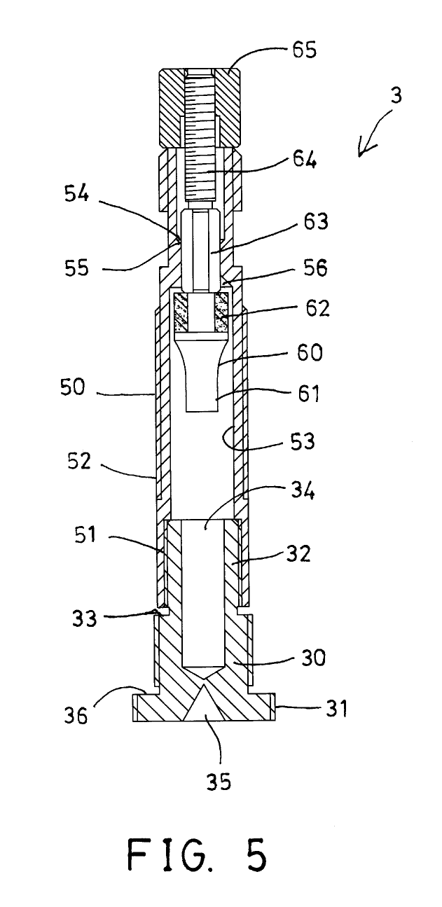

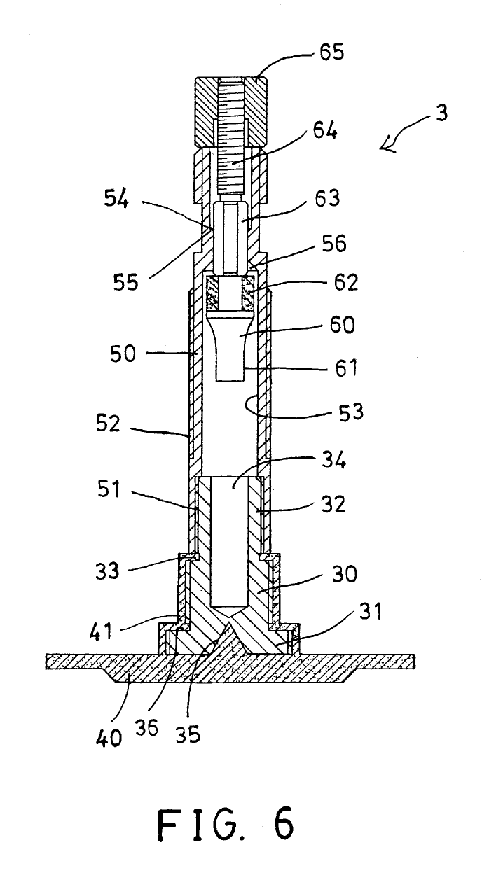

The valve stem 30 further includes a bore 34, such as a blind bore 34 formed therein, and primarily formed in the valve stem 30 and the threaded segment 32, and includes a V-shaped notch 35 formed in the flanged head 31 (FIGS. 5, 6) and aligned with the bore 34 of the valve stem 30, and the flanged head 31 is to be drilled or machined to communicate the bore 34 and the notch 35 of the valve stem 30 with each other (FIGS. 1-2, 7) which will be discussed hereinafter. The valve stem 30 further includes an annular abutment 36 formed between the valve stem 30 and the flanged head 31 for stably and effectively engaging with the bridge 13 and for anchoring or securing or retaining or positioning the valve stem 30 to the bridge 13 of the wheel rim member 10.

A sealing member 40 is attached or mounted or secured to the flanged head 31 of the valve stem 30, such as applied or molded to the valve stem 30, and includes an outer diameter greater than that of the flanged head 31 of the valve stem 30 for engaging with the bridge 13 and for further anchoring or securing or retaining or positioning the valve stem 30 to the bridge 13 of the wheel rim member 10 and for making an air tight seal between the valve stem 30 and the wheel rim member 10. The sealing member 40 further includes a covering or molding or casing 41 optionally molded and engaged onto or around the flanged head 31 and/or the valve stem 30 for further engaging with the bridge 13 and/or for engaging between the valve stem 30 and the bridge 13 and for further making an air tight seal between the valve stem 30 and the wheel rim member 10.

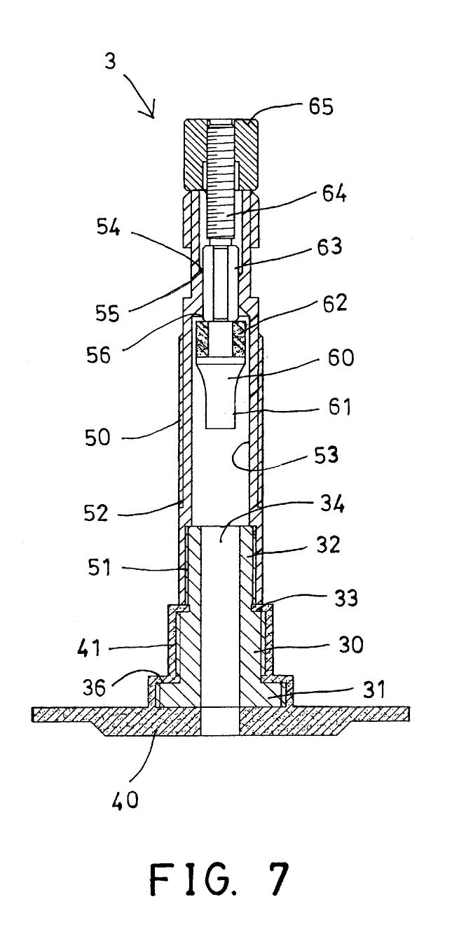

The covering or molding or casing 41 is molded and engaged onto the annular abutment 36 that is formed between the valve stem 30 and the flanged head 31 for engaging with the bridge 13 of the wheel rim member 10. It is preferable, but not necessarily that the covering or molding or casing 41 is molded and engaged onto the annular shoulder 33 that is formed between the valve stem 30 and the threaded segment 32. After the sealing member 40 is molded and engaged onto the flanged head 31 and/or the valve stem 30 (FIG. 6), the flanged head 31 of the valve stem 30 is drilled or machined to communicate the bore 34 and the notch 35 of the valve stem 30 with each other, or to open the bore 34 of the valve stem 30 (FIG. 7), and to allow the air to flow into and through the bore 34 of the valve stem 30.

The valve device 3 further includes a tube 50 for engaging into or through the orifice 17 that is formed in the base 12 of the wheel rim member 10, and the tube 50 includes an inner thread 51 formed thereon, such as formed in the inner end portion thereof for threading or engaging with the threaded segment 32 of the valve stem 30 and for attaching or mounting or securing or coupling the tube 50 to the valve stem 30, and includes an outer thread 52 formed thereon for threading or engaging with the wheel rim member 10 directly, or indirectly with a fastener 90 and for solidly and stably attaching or mounting or securing or anchoring or retaining the valve stem 30 and the tube 50 of the valve device 3 to the wheel rim member 10.

The tube 50 further includes an orifice or bore or through hole or compartment 53 formed therein, and includes an inner peripheral protrusion or one or more guide ribs 54 extended radially and inwardly into the compartment 53 thereof for forming or defining one or more guide slots 55 therein, and for forming or defining a valve seat 56 in the tube 50. A valve core or shank or piece 60 is slidably received or engaged in the compartment 53 of the tube 50 and includes an enlarged valve head 61 received or contained in the compartment 53 of the tube 50 for selectively engaging with the valve seat 56 of the tube 50, and includes another sealing member or seal or gasket 62 engaged onto the valve piece 60 and engaged with the valve head 61 for selectively engaging with the valve seat 56 of the tube 50 (FIG. 2) and for selectively blocking or sealing the compartment 53 of the tube 50.

The valve piece 60 includes one or more guide slots or projections or guide members 63 extended radially and outwardly therefrom for selectively engaging with the guide slots 55 or the guide ribs 54 of the tube 50 and for guiding the valve piece 60 to slide along or relative to the tube 50 only and for preventing the valve piece 60 from being rotated relative to the tube 50, and thus for guiding the gasket 62 or the valve head 61 to move toward or away from the valve seat 56 of the tube 50. The valve piece 60 further includes a threaded shank 64 formed or provided thereon and extendible out of the tube 50 for threading or engaging with a lock nut 65 which is engaged with the tube 50 and which may move the gasket 62 or the valve head 61 toward or away from the valve seat 56 of the tube 50. The lock nut 65 includes an opening 66 formed therein and arranged for allowing the air to flow into the compartment 53 of the tube 50 even when the lock nut 65 is solidly engaged with the tube 50.

In operation, as shown in FIG. 1, when the gasket 62 or the valve head 61 is disengaged or moved away from the valve seat 56 of the tube 50, the air may flow into the compartment 53 of the tube 50 and may flow through the valve seat 56, and may then flow through the bore 34 of the valve stem 30 and into the tubeless tire (not illustrated). As shown in FIG. 2, the gasket 62 or the valve head 61 may be selectively moved to engage with the valve seat 56 of the tube 50 and to selectively block or seal the compartment 53 of the tube 50 and thus to prevent the air from flowing into the compartment 53 of the tube 50 and from flowing through the valve seat 56, and from flowing through the bore 34 of the valve stem 30 and from flowing into the tubeless tire.

It is to be noted that the sealing member 40 is solidly attached or mounted or secured or molded to the valve stem 30, and includes a casing 41 solidly engaged onto the flanged head 31 and/or the valve stem 30 for engaging with the bridge 13 or the wheel rim member 10 and for making an air tight seal between the valve stem 30 and the wheel rim member 10. The tube 50 and the valve stem 30 are two separated pieces, and the valve stem 30 includes a short or reduced dimension or volume for allowing the valve stem 30 to be easily engaged into a molding machine (not illustrated) and for allowing the sealing member 40 to be easily and solidly attached or mounted or secured or molded onto the valve stem 30, and thus for making a solid air tight seal between the valve stem 30 and the wheel rim member 10.

Accordingly, the valve device in accordance with the present invention is provided for attaching to a wheel rim assembly of a tubeless tire, particularly those used in show cars, bicycles, motor cycles, tricycles, unicycles, or the like, including a solid and stable air tight seal.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A wheel rim assembly comprising:
a rim member including two side walls, and including a bridge extending between said side walls, and including an aperture formed in said bridge, and
a valve device including a valve stem engaged with said aperture of said rim member, and including a sealing member attached to said valve stem for engaging with said bridge and for anchoring said valve stem to said bridge of said rim member and for making an air tight seal between said valve stem and said rim member, and said sealing member including a casing engaged onto said valve stem and engaged between said valve stem and said bridge for making the air tight seal between said valve stem and said rim member.

2. The wheel rim assembly as claimed in claim 1, wherein said valve stem includes a flanged head having an outer diameter greater than that of said valve stem for forming an abutment between said valve stem and said flanged head and for engaging with said bridge and for anchoring said valve stem to said bridge of said rim member.

3. The wheel rim assembly as claimed in claim 2, wherein said casing is engaged onto said flanged head and said abutment of said valve stem for engaging with said bridge.

4. The wheel rim assembly as claimed in claim 1, wherein said valve device includes a tube attached to said valve stem, and includes a compartment formed in said tube, and includes a valve seat formed in said tube, and includes a valve piece received in said compartment of said tube and having a valve head for selectively engaging with said valve seat of said tube.

5. The wheel rim assembly as claimed in claim 4, wherein said valve piece includes a gasket engaged with said valve head for selectively engaging with said valve seat of said tube and for selectively blocking said compartment of said tube.

6. The wheel rim assembly as claimed in claim 5, wherein said gasket is engaged onto said valve piece and engaged with said valve head.

7. The wheel rim assembly as claimed in claim 4, wherein said tube includes at least one guide rib extended in said compartment thereof, and said valve piece includes at least one guide member for engaging with said at least one guide rib of said tube and for guiding said valve piece to slide along said tube and for preventing said valve piece from being rotated relative to said tube, and for guiding said valve head to move toward or away from said valve seat of said tube.

8. The wheel rim assembly as claimed in claim 7, wherein said valve device includes a lock nut threaded with a threaded shank of said valve piece and engaged with said tube for moving said valve head toward or away from said valve seat of said tube.

9. The wheel rim assembly as claimed in claim 8, wherein said lock nut includes an opening formed therein and arranged for allowing the air to flow into said compartment of said tube.

10. The wheel rim assembly as claimed in claim 4, wherein said tube includes at least one guide slot formed therein, and said valve piece includes at least one guide member for engaging with said at least one guide slot of said tube and for guiding said valve piece to slide along said tube and for preventing said valve piece from being rotated relative to said tube, and for guiding said valve head to move toward or away from said valve seat of said tube.

11. The wheel rim assembly as claimed in claim 4, wherein said valve stem includes a threaded segment threaded with said tube for attaching said tube to said valve stem, and said threaded segment includes an outer diameter smaller than that of said valve stem for forming an annular shoulder between said valve stem and said threaded segment.

12. The wheel rim assembly as claimed in claim 11, wherein said casing is engaged onto said annular shoulder of said valve stem for engaging with said tube.

13. The wheel rim assembly as claimed in claim 4, wherein said tube includes an outer thread formed thereon for engaging with a fastener and for mounting said tube of said valve device to said rim member.

14. The wheel rim assembly as claimed in claim 13, wherein said side walls of said rim member are converge and are joined together to form a base, and said base includes an orifice formed therein for receiving and engaging with said tube.
